(19) United States
(12) Patent Application Publication
(10) Pub. No.: US 2021/0333000 A1
(43) Pub. Date: Oct. 28, 2021

(54) HIGH EFFICIENCY MODE-DEPENDENT HEATING AND COOLING SYSTEMS

(71) Applicant: Rheem Manufacturing Company, Atlanta, GA (US)

(72) Inventor: Cameron Wright, Indianapolis, IN (US)

(21) Appl. No.: 16/860,230

(22) Filed: Apr. 28, 2020

(51) Int. Cl. F24F 11/46; F24F 11/65; F24F 11/72; F24F 11/80; G05B 19/042

(52) U.S. Cl. CPC F24F 11/46; F24F 11/65; F24F 2130/10; F24F 11/80; G05B 19/042; F24F 11/72

(57) ABSTRACT

A heating, ventilation, and air condition (HVAC) system is disclosed. The HVAC system includes mode-dependent, movable barriers that can open and close to increase the efficiency of the systems. The movable barriers can be positioned proximate either a gas furnace heat exchanger or air conditioning coils. In a closed configuration, the movable barriers constrict a portion of air flow through a cabinet or other air flow conduit. The movable barriers can be activated by several means including blower airflow, springs, motors, or other such motion devices. Redundancies are also described to ensure the movable barriers are in the proper position. The redundancies described include sensors that measure the condition of the air itself as well as sensors to directly detect the position of the movable barriers.

### FIELD OF THE DISCLOSURE

Examples of the present disclosure relate generally to heating, air conditioning, and ventilation systems and, more specifically, to heating, air conditioning, and ventilation systems with mode-dependent barriers that can adjust to increase the efficiency of the systems within each operating mode.

### BACKGROUND

A common design for residential and commercial heating, air conditioning, and ventilation (HVAC) systems include a combination system having a heat exchanger for providing warm air and air conditioning coils to provide cool air. Typically, the gas furnace heat exchanger and the air conditioning coils are placed in series such that the air conditioning coils sits on top of the gas furnace, and a single blower can provide air through both systems. This design provides both space conservation and minimizes system cost.

One drawback to the current dual-purpose HVAC systems is that, if the system is designed with one of the processes (e.g., heating or cooling) in mind, the cabinet may not be configured most efficiently for the other process. Consider, for example, an HVAC system in the Southern United States. In this environment, the HVAC system may have a small heat exchanger (e.g., two ton) matched with large air conditioning system (e.g., four ton), because the summers are comparatively hotter than the winters are cool. The opposite is true, of course, in the Northern United States, where HVAC systems have a larger heat exchanger than air conditioning system.

By putting the two systems in series, a new inefficiency can be created. Using the example above that is configured with air conditioning in mind, the blower is set to provide a certain amount of air flow through the cabinet. Baffles or other barriers may be provided around the heat exchanger to ensure the air flow is heated by the exchanger as it passes through the cabinet when in the heating mode. When the HVAC system is in cooling mode, however, the blower motor consumes additional power than would otherwise be required because it must drive the high air-conditioning air flow through the cabinet and past the baffles. To this end, existing systems can provide solutions for efficient air conditioning or efficient heating but cannot typically provide efficient solutions for both. What is needed, therefore, are systems and methods for increasing the efficiency of HVAC systems that are configured for both heating and cooling modes.

### BRIEF SUMMARY

These and other problems can be addressed by the technologies described herein. Examples of the present disclosure relate generally to HVAC systems and, more specifically, to HVAC systems with mode-dependent barriers that can open and close to increase the efficiency of the systems.

The present disclosure provides a system for heating and cooling. The system can include one or more movable barriers configured to transition between an open configuration and a closed configuration. When at least one movable barrier of the one or more movable barriers is in the closed configuration, the at least one movable barrier can block a portion of an air flow conduit such that an air flow flowing through the air flow conduit is redirected. The opening and closing of the movable barriers can be facilitated by a controller configured to output a control signal based on whether the system is in a heating mode or a cooling mode.

The one or more movable barriers can be positioned proximate a heat exchanger of the system such that, when the at least one moveable barrier is in the closed configuration, the at least one moveable barrier can direct the air flow across the heat exchanger. By directing the heat across the heat exchanger, the system can ensure more heat is applied to the passing air as a larger portion of the air is passed near the heat exchanger. When the system is in a cooling mode, the one or more movable barriers can be opened, for example by the control signal, to enable the air to flow freely through the conduit and not be redirected specifically across the heat exchanger. The system can include air conditioning coils to cool the air when the system is in a cooling mode.

The movable barriers can be moved in a variety of ways. The barriers can be moved by a motor in electrical communication with the controller. In other examples, the air flowing through the conduit can transition the movable barriers from an open configuration to a closed configuration, and a spring can move the barriers back to the open configuration. A solenoid can lock the movable barriers in their intended configuration.

Redundancies are described herein to ensure the system is running properly. Temperature sensors, pressure sensors, flow sensors, and the like can be provided to monitor the condition of the air flowing through the conduit. Information from the various sensors can be used to determine if the system is heating when it is in a cooling mode or vice versa. Additional sensors can be used to monitor the position of the movable barriers. By monitoring the condition of the air flow and the position of the movable barriers, the system can ensure the system is not producing heat while the movable barriers are open and/or, conversely, producing cool air while the movable barriers are closed.

The present disclosure provides a heating, ventilation, and air conditioning (HVAC) system. The HVAC system can include an outer cabinet. The HVAC system can include a blower. The blower can be configured to provide an air flow through the outer cabinet. The HVAC system can include a movable barrier having an open configuration and a closed configuration. The movable barrier can be configured to constrict air flow through the outer cabinet when in the closed configuration. This constriction of the air flow can be used to focus the air flow across a heat exchanger, for example. The HVAC system can include a controller configured to output a control signal with instructions to move the movable barrier from the open configuration when the HVAC system is in a cooling mode to the closed configuration when the HVAC system is in a heating mode.

The present disclosure also describes the controller in greater detail and provides methods of controlling the systems described herein using the controller. These and other aspects of the present disclosure are described in the Detailed Description below and the accompanying figures. Other aspects and features of the present disclosure will become apparent to those of ordinary skill in the art upon reviewing the following description of specific examples of the present disclosure in concert with the figures. While features of the present disclosure may be discussed relative to certain examples and figures, all examples of the present disclosure can include one or more of the features discussed herein. Further, while one or more examples may be discussed as having certain advantageous features, one or more of such features may also be used with the various other examples of the disclosure discussed herein. In similar fashion, while examples may be discussed below as devices, systems, or methods, it is to be understood that such examples can be implemented in various devices, systems, and methods of the present disclosure.

### BRIEF DESCRIPTION OF THE DRAWINGS

The accompanying drawings, which are incorporated in and constitute a part of this specification, illustrate multiple examples of the presently disclosed subject matter and serve to explain the principles of the presently disclosed subject matter. The drawings are not intended to limit the scope of the presently disclosed subject matter in any manner. In the drawings:

FIGS. 1A and 1B provide illustrations of example prior-art furnaces;

FIGS. 2A and 2B depict an example HVAC system including movable barriers, in accordance with the present disclosure;

FIG. 3 depicts an example HVAC system having AC coils in series with a heat exchanger, in accordance with the present disclosure;

FIGS. 4A and 4B depict an example movement system for opening and/or closing movable barriers, in accordance with the present disclosure;

FIGS. 5A-5C depict additional example movement systems for opening and/or closing a movable barrier, in accordance with the present disclosure;

FIG. 6A illustrates an example diagram of an HVAC system with a controller, in accordance with the present disclosure;

FIG. 6B illustrates a component diagram of an example controller, in accordance with the present disclosure;

FIG. 7 illustrates a flowchart showing an example process for a controller, in accordance with the present disclosure;

FIG. 8 illustrates an example process flow for using a temperature sensor as a redundancy for an HVAC system, in accordance with the present disclosure;

FIG. 9 illustrates an example process flow for using a sensor as a redundancy for an HVAC system, in accordance with the present disclosure;

FIG. 10 is an example process flow for responding to a call for heat and providing heat through the system, in accordance with the present disclosure; and

FIG. 11 is an example process flow for responding to a call for cooling and providing air conditioning through the system, in accordance with the present disclosure.

### DETAILED DESCRIPTION

A traditional blower system, be it a furnace or air conditioning system, includes a blower that supplies air flow through an outer cabinet, and the cabinet channels the air flow through a heat exchanger and/or an air conditioning coil before exiting the cabinet through ventilation ducts. In many systems, a manufacturer may use the same outer cabinet for several differently rated systems. For example, a 17-inch cabinet may be used for both a 50,000 BTU rated furnace and a 100,000 BTU rated furnace. Instead of changing the dimensions of the cabinet, the size and, therefore, the output of the system can be altered by changing the rating of the heat exchanger or the air conditioning coils.

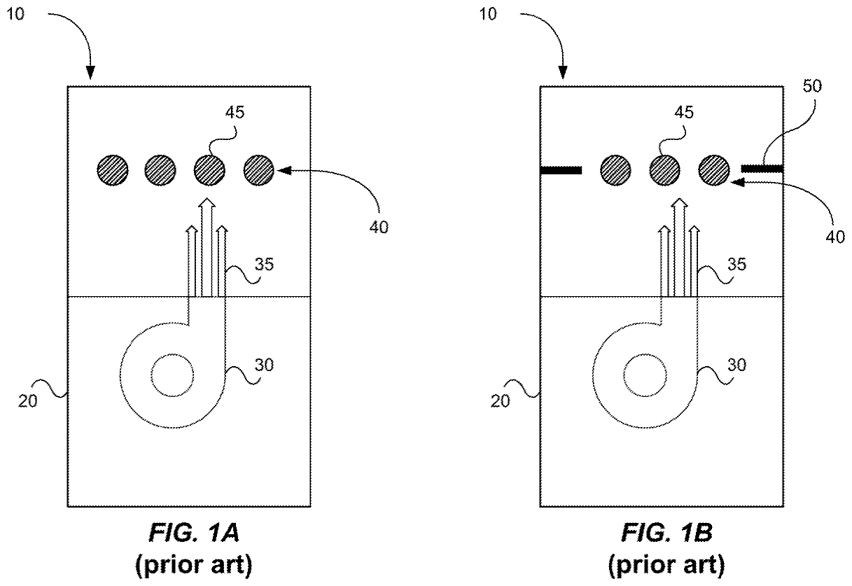

FIGS. 1A and 1B provide prior-art illustrations of this principle using an example furnace 10. In each figure, the example furnace 10 has the same or similar cabinet 20 and blower 30, but the heat exchanger 40 is larger in FIG. 1A than in FIG. 1B. The example furnace 10 in FIG. 1A includes four heating tubes 45, for example, and the furnace 10 in FIG. 1B includes three heating tubes 45. The furnace 10 in FIG. 1A, therefore, could be expected to have a higher rating and deliver more heat to the air flow 35.

A common design for systems with a smaller heat exchanger 40, for example the furnace of FIG. 1B, is to include fixed baffles 50 within the cabinet to redirect the air flow 35 across the heat exchanger 40. These fixed baffles 50 are added for a number of reasons. First, by redirecting the air flow 35 across the heat exchanger 40, the fixed baffles 50 can prevent air passing along the outer wall of the cabinet 20 and away from the heating tubes 45, which can permit substantially unheated air from effectively bypassing the heat exchanger 40 and can thus decrease the overall temperature of the heated air and the efficiency of the system. Stated otherwise, the fixed baffles 50 can ensure more heat is applied to the passing air (e.g., via conduction and convection) as a larger portion of the air is passed near the heat exchanger 40. Second, the fixed baffles 50 can locally direct the air flow 35 so that the heat exchanger 40 does not overheat. In systems with a larger heat exchanger 40, the addition of more heating tubes 45 can serve to constrict or redirect the air flow 35 in lieu of the fixed baffles 50. However, merely increasing the rating of the heat exchanger 40 may not be an optimal solution, because the furnace system may be installed in a location that does not require the increased rating (e.g., in warmer climates). To this end, merely increasing the rating of the heat exchanger 40 can decrease the efficiency of the system if the increased rating is not necessary for the particular use of the system can also otherwise unnecessarily increase installation costs, and/or excessive operational costs.

As described above, many HVAC systems include both a heat exchanger and air conditioning unit in series, so that heating and cooling can be provided via the same cabinet. In these scenarios, the inclusion of the fixed baffles 50 in FIGS. 1A and 1B can severely limit the HVAC system when the system is in a cooling mode. The reasons for the fixed baffles 50 described above apply to increasing the efficiency of a heat exchanger, they do not apply to providing cool air. With fixed baffles 50 in place, therefore, the air flow 35 provided through air-conditioning coils (not shown in FIGS. 1A and 1B) for cooling is also constricted or redirected by the fixed baffles 50.

The interest of HVAC manufacturers to increase system efficiency in both heating and cooling modes is not limited to an interest in providing a cost-effective, long-lasting product to consumers. Recently, the United States Department of Energy promulgated regulations (e.g., the Jul. 3, 2019 Fan Furnace Efficiency Rating (FER) regulations) that aim to reduce the energy consumption of HVAC blowers in newly manufactured systems. To comply with these regulations and generally increase the efficiency of HVAC systems, it can be useful to provide different operating modes (i.e., heating or cooling) that can each increase efficiency of the system for a particular type of performance (e.g., heating, cooling) and thus decrease the overall electrical energy consumption of the system.

Various systems and methods are disclosed for HVAC systems with mode-dependent barriers that can open and close to increase the efficiency of the systems, and example systems and methods will now be described with reference to the accompanying figures.

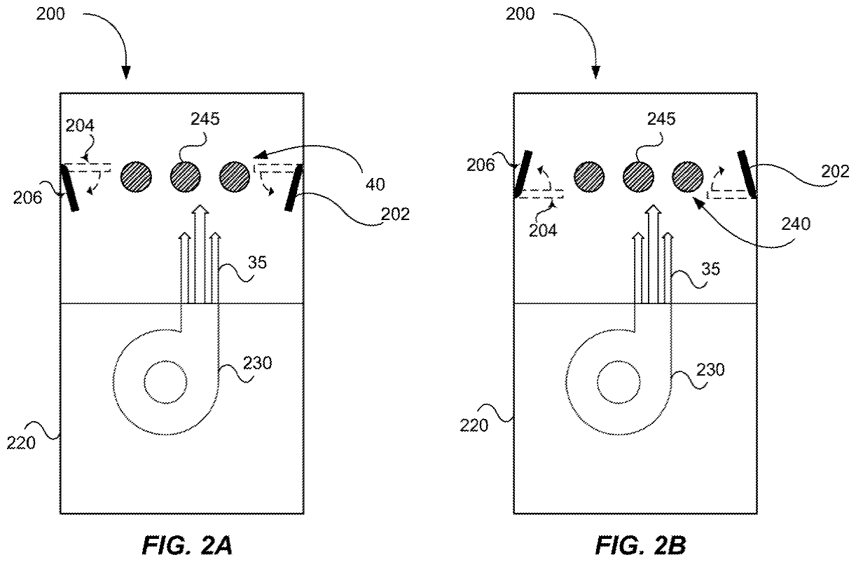

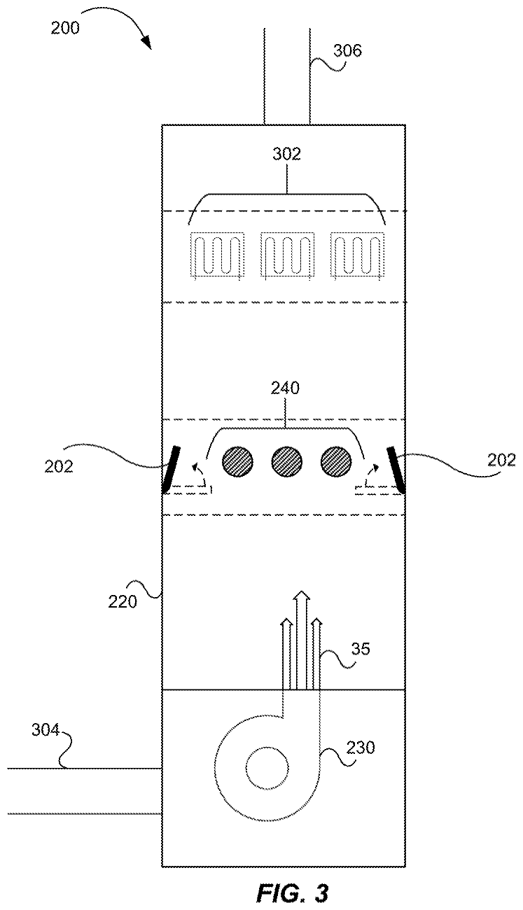

FIGS. 2A and 2B depict an example HVAC system 200 with movable barriers 202. The example HVAC system 200 in FIGS. 2A and 2B show only the inclusion of heat exchangers 240 (e.g., similar to heat exchanger 40), but the HVAC system 100 can also include an air-conditioning unit (e.g., air-conditioning (AC) coils 302 in FIG. 3). The heat exchanger 240 in FIGS. 2A and 2B show a plurality of heating tubes 245 (e.g., similar to heating tubes 45). Other types of heat exchangers 240 and/or heating elements can be used in the present system, however, including, but not limited to gas furnace tubes, heat pump coils, electric heating packages, and any system element used to transfer heat or otherwise modify the condition of the air (for example air cleaners, humidifiers, purifiers, etc.).

The movable barriers 202 can be baffles, walls, dampers, or other obstructions capable of selectively constricting and/or redirecting air flow 35 through the cabinet 220 (e.g., similar to cabinet 20). The cabinet 220 acts as an air flow conduit for the HVAC system, though other air-flow conduits could take the place of an outer cabinet 220. When one or more of the movable barriers 202 is in the closed configuration, a portion of the air flow conduit (e.g., cabinet 220) can be blocked such that the air flow 35 flowing through the conduit is constricted and redirected across the heat exchanger 240. The HVAC system 200 can include two movable barriers 202 positioned at opposite ends of the heat exchanger 240, as shown in FIGS. 2A and 2B. Alternatively, or in addition, the HVAC system 200 can include a single movable barrier 202 at one side of the heat exchanger 240. The HVAC system 200 can include more than two movable barriers 202; for example, each wall of a rectangular cross-sectioned cabinet 220 can include a movable barrier 202. Alternately or in addition, one side of the cabinet 220 can include a movable barrier 202, while another side can include a fixed barrier (e.g., similar to the fixed baffle 50 of FIG. 1B).

The movable barriers 202 can have a closed configuration 204 positioned proximate the heat exchanger 240 and move to an open configuration 206, thereby opening the cabinet 220 for increased air flow 35. As described above, the movable barriers 202 can be set to the closed configuration 204 when the HVAC system 200 is in a heating mode. This can assist in constricting the air flow 35 proximate the heat exchanger 240 and ensure a larger portion of the air flow 35 flows more closely to the heat source. Positioning the movable barriers 202 in a closed configuration 204 when in a heating mode redirects the air flow 35 so that the heat exchanger 240 does not overheat. The movable barriers 202 can be set to the open configuration 206 when the HVAC system 200 is in a cooling mode. This open configuration 206 can enable the air flow 35 to travel through the cabinet 220 more freely when the air does not need to be heated by the heat exchanger 240. As will be understood, the positions of the movable barriers 202 are not limited to only an open and a closed configuration, and any system described herein can also include an intermediate position between open and closed. This can enable the system to fine tune the amount of air flow 35 being directed across the heat exchanger 240.

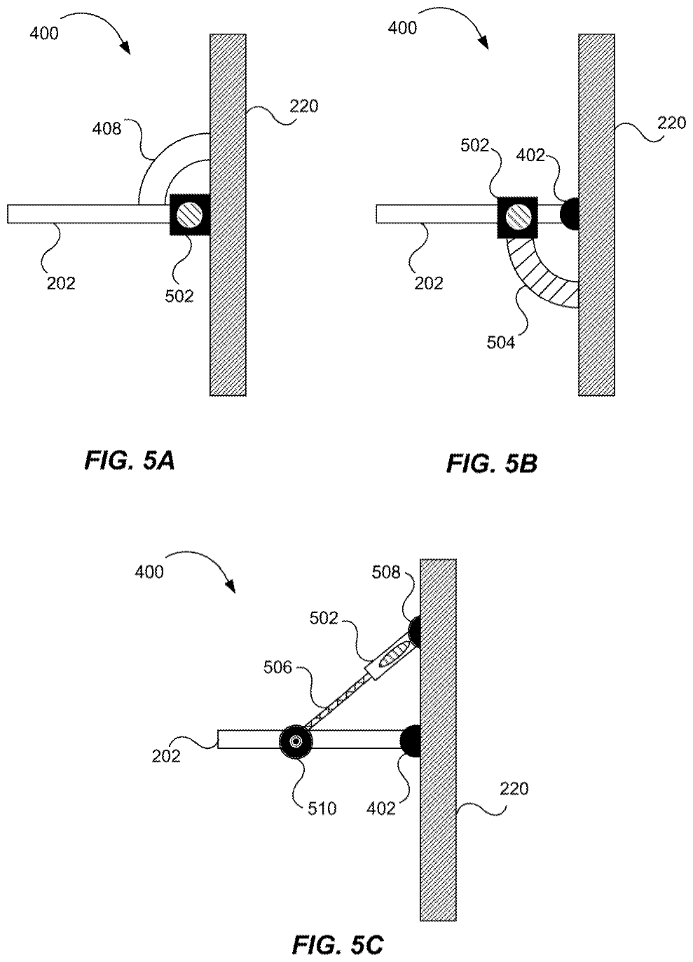

The movable barriers 202 can open either toward the blower (e.g., as shown in FIG. 2A) or away from the blower (e.g., as shown in FIG. 2B). This enables the movable barriers 202 to have different opening and/or closing dynamics. For example, if the movable barriers 202 open toward the blower 230 (FIG. 2A), the air flow 35 can be used as a redundancy to ensure the movable barriers 202 are closed if the system fails when the HVAC system is in a heating mode. The air flow 35, for example, can be used to close the movable barriers 202. This example is described in greater detail with reference to FIGS. 5A and 5B.

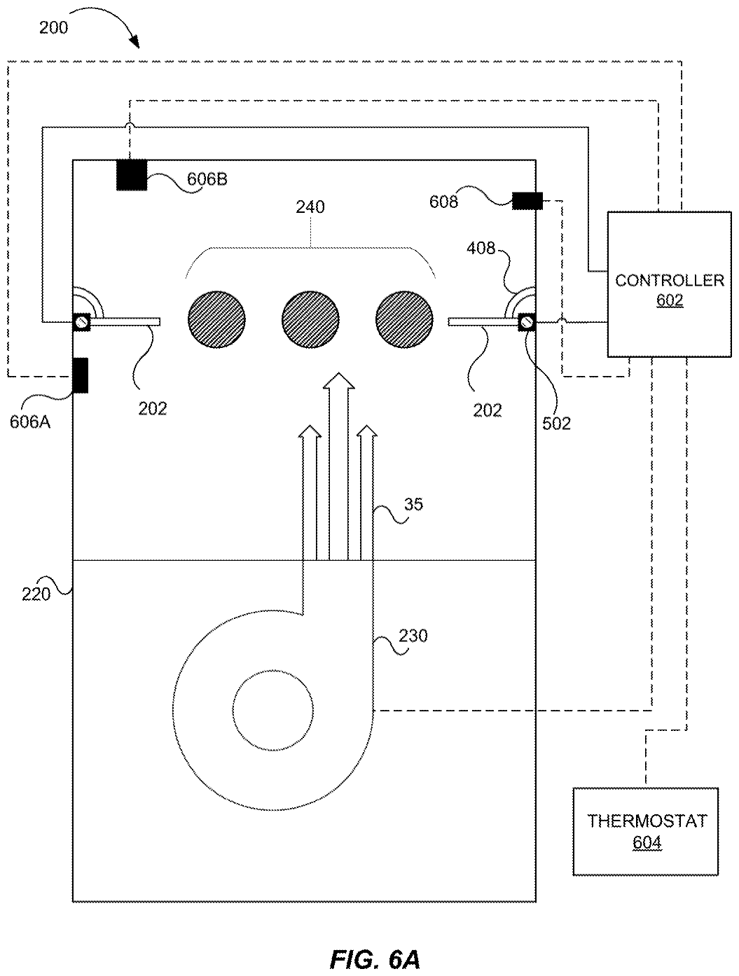

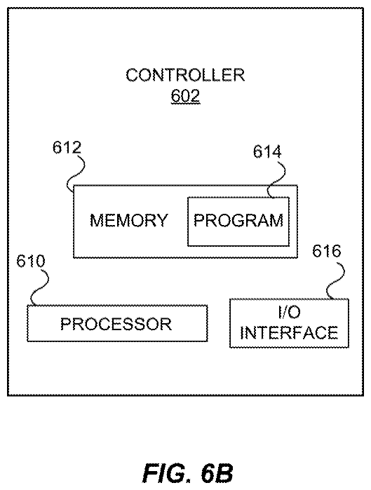

FIG. 3 depicts an example HVAC system 200 with AC coils 302 in series with the heat exchanger 240, according to some examples of the present disclosure. As described above, many HVAC systems 200 are configured to provide both heating and cooling to a building. To do so, the heat exchanger 240 and AC coils 302 can be placed in series, and the blower 230 can provide air through both units. When the HVAC system is in cooling mode, the blower 230 receives air from a return air duct 304 and passes the air flow 35 through the cabinet 220, around the activated AC coils 302, and through output ducts 306. The heat exchanger 240 is not operating when the HVAC system 200 is in cooling mode. The present system and methods, therefore, enable the movable barriers 202 to be opened to reduce the obstruction of the air flow 35. When the HVAC system 200 is in the heating mode, the AC coils 302 are deactivated, and the blower 230 receives air from the return air duct 304 and passes the air flow 35 through the cabinet 220, around the activated heat exchanger 240, and through output ducts 306. When in heating mode, the movable barriers 202 can be closed (e.g., be positioned proximate to the heat exchanger 240) to increase the heating efficiency. As will be described in greater detail with reference to FIG. 6A, the opening and/or closing of the movable barriers 202 can be completed with a controller 602 in communication with the components of the HVAC system 200.

As described above, some example HVAC systems 200 may be optimized to provide more air conditioning than they do heating. For example, HVAC systems in cooler climates may include proportionally larger heating capacity than cooling capacity. In such climates, it can be advantageous to locate the movable barrier 202 proximate the AC coils 302 instead of proximate the heat exchanger 240. The same dynamics as described herein for movable barriers 202 placed near the heat exchanger 240 can be true for movable barriers 202 placed near the AC coils 302. The movable barriers 202 can be commanded to a closed configuration when the HVAC system 200 is in a cooling mode. This would ensure that the air flows more closely to the comparatively smaller air conditioning unit. When the HVAC system 200 is set to the heating mode, the movable barriers 202 can be commanded to an open configuration, thereby enabling the air to flow more closely to the heat exchanger 240. In these examples, the heat exchanger 240 may be more robust, like the example shown in FIG. 1A, and the movable barriers 202 may not be necessary, because the larger heat exchanger 240 can be sized to sufficiently heat passing air without the need to constrict the air flow 35 (e.g., with movable barriers 202). It is contemplated that the HVAC system 200 can include movable barriers 202 placed proximate the heat exchanger 240 and the AC coils 302. In these examples, the movable barriers 202 can work in tandem, one opening when necessary for heating, another opening when necessary for cooling.

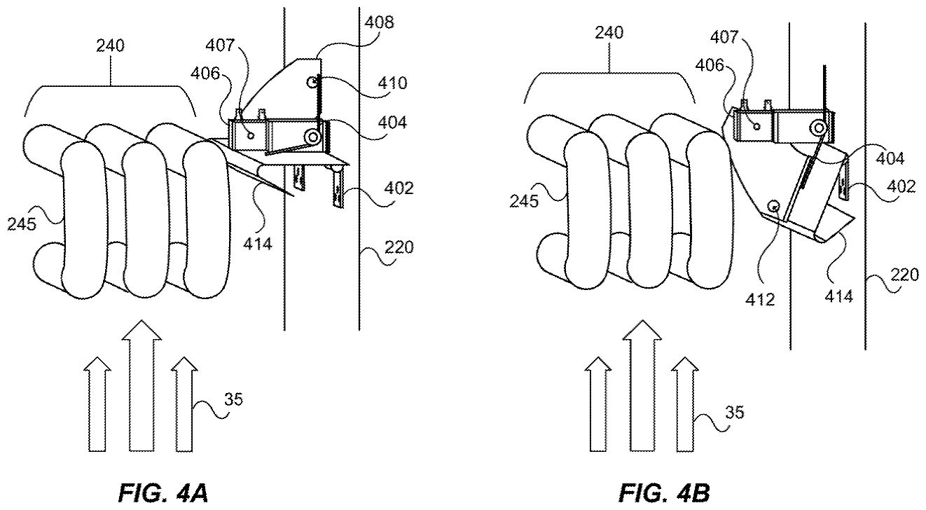

Various devices and methods can be employed to move the movable barriers 202 from a closed configuration to an open configuration, and vice versa. FIGS. 4A-6B depict various system environments for completing the transition of the movable barriers 202.

FIGS. 4A and 4B depict an example movement system 400 for opening and/or closing the movable barriers 202, according to some examples of the present disclosure. FIGS. 4A and 4B show an example movement system 400 that enables the air flow 35 to provide a redundancy that ensures the movable barriers 202 are closed if the system fails when the HVAC system is in a heating mode. This example movement system 400 generally corresponds to the example system described with reference to FIG. 2A, where the movable barriers 202 have an open configuration 206 directed toward the blower 230. The movable barrier 202 can be connected to the wall of the cabinet 220 via a hinge 402, enabling the movable barrier 202 to move from closed configuration (FIG. 4A) to an open configuration (FIG. 4B).

A torsion spring 404 can be positioned between the movable barrier 202 and the wall of the cabinet 220. The torsion spring 404 can be pre-loaded such that the spring is biased toward the open configuration (FIG. 4B). The pre-loaded torsion in the torsion spring 404 can be low enough that the movable barrier 202 can be closed by the air flow 35 moving through the cabinet 220.

A solenoid 406 can be positioned on a stop plate 408 to lock the movable barrier 202 into its desired configuration (e.g., open or closed). The stop plate 408 can be a positive stop that prevents the movable barrier 202 from closing beyond its final, closed configuration. For example, in FIG. 4A, the stop plate 408 is abutting the wall of the cabinet 220, thereby prohibiting the movable barrier 202 from closing beyond this position. The stop plate 408 can include an open-locking hole 410 and a closed-locking hole 412 to accept the de-energized solenoid 406 pin 407. To illustrate, the example movable barrier 202 in FIG. 4A is locked into the closed configuration by a pin 407 of the de-energized solenoid 406 being inserted into a closed-locking hole 412. The closed-locking hole 412 is obstructed in the view of FIG. 4A but is shown in FIG. 4B. The solenoid 406 can be energized, thereby pulling the pin 407 from the closed-locking hole 412. The torsion spring 404 can then cause the movable barrier 202 to hinge from the closed configuration to the open configuration. The solenoid 406 can be de-energized to allow the pin 407 to insert into the open-locking hole 410 (hole shown unobstructed in FIG. 4A), thereby locking the movable barrier 202 into the open configuration.

The movement system 400 can include a flange 414 that can prevent the movable barrier 202 from opening beyond a desired position in the open configuration. The flange 414, for example, can ensure a certain amount of space is present between the movable barrier 202 and the wall of the cabinet 220. This can enable air flow 35 to be directed between under the movable barrier 202 to close the movable barrier 202. The flange 414 can extend from the movable barrier 202 itself, as shown in FIGS. 4A and 4B. Alternatively, the flange 414 can extend from the wall of the cabinet 220. Regardless, the flange 414 can have any shape or configuration that can provide space between the movable barrier 202 and the wall of the cabinet 220, for example the flange 414 can be a solid flange (as shown), a leg, a peg, another extension, or any other shape or configuration.

The following is an example control method for a movement system 400 that can employ the example system shown in FIGS. 4A and 4B. A pin 407 of the solenoid 406 can be inserted into a closed-locking hole 412, thereby locking the movable barrier 202 into a closed configuration, where the movable barrier 202 is positioned proximate the heat exchanger 240. The blower 230 can be commanded off (e.g., by the controller 602 described with reference to FIGS. 6A and 6B). The solenoid 406 can be energized to retract the pin 407. Once the pin 407 is retracted, the torsion spring 404 can cause the movable barrier 202 to hinge to the open configuration. The solenoid 406 can be de-energized to insert the pin 407 into the open-locking hole 410. The movable barrier 202 is then locked into an open configuration, and the blower 230 can be commanded on to provide air flow 35. At this step, cooling coils can be activated as well to cool the air flow 35.

To return the HVAC system to the heating mode, the solenoid 406 can be energized to retract the pin 407 from the open-locking hole 410. At this step, the cooling coils can be deactivated. The air flow 35 from the blower 230 can push the unlocked movable barrier 202 into the closed configuration. The solenoid 406 can be de-energized again to insert the pin 407 into the closed-locking hole 412. The movable barrier 202 is therefore locked into the closed configuration. At this step, the heat exchanger 240 can be activated to provide heat to the air flow 35.

FIGS. 5A-5C depict example movement systems 400 that include motorized systems for opening and/or closing a movable barrier 202. The example described above with reference to FIGS. 4A and 4B can be designed to use the movement of air through the cabinet 220 to close the movable barriers 202. FIGS. 5A-5C provide example systems for opening and/or closing a movable barrier 202 using motorized means that do not rely on the air flow 35. FIG. 5A depicts an example movement system 400 having a motor 502 for opening and/or closing the movable barrier 202. The motor 502 can connect the movable barrier 202 to the cabinet 220. The motor 502 can include a servo motor, a rotary actuator, a step motor, a torque motor, worm-drive motor, and/or the like that can move the movable barrier 202 from an open configuration to a closed configuration.

The movement system 400 can also include a stop plate 408, as described above, to prevent the movable barrier 202 from closing beyond a predetermined location. Using FIG. 5A for illustration, the example movement system 400 includes a movable barrier 202 that opens counterclockwise (the figure shows the movable barrier 202 in the closed configuration). The stop plate 408, again, can act as a positive stop to prevent the movable barrier 202 from closing beyond the horizontal position (as shown) by abutting the wall of the cabinet 220 when the movable barrier 202 reaches the horizontal position. The horizontal position may be beneficial to redirect air flow 35 through the cabinet 220, but it will be appreciated that nothing requires the final closed configuration to be a horizontal position. In addition, the stop plate 408 acting as a positive stop in the closed configuration can be a proper fail safe. Should the system fail for any reason, it may be desirable for the system to fail in a closed configuration such that the air flow 35 causes the movable barriers 202 to remain closed.

FIG. 5B shows an example movement system 400 that includes a motor 502 that moves upon a track 504. The example movement system 400 in FIG. 5B also includes a movable barrier 202 that opens counterclockwise, like the one shown in FIG. 5A. The motor 502 can be positioned along the length of the movable barrier 202, and the motor 502 can move along the track 504. The track 504, therefore, can act to prevent the movable barrier from closing beyond a predetermined position (e.g., horizontal) like the stop plate 408 described above.

FIG. 5C shows an example movement system 400 that includes a shaft 506 that pulls and pushes the movable barrier 202 into place. The motor 502 can be a linear actuator that is connected to the cabinet 220 via first hinge 508, the shaft 506 can be connected to the movable barrier 202 at a second hinge 508, and the movable barrier 202 can connected to the cabinet 220 at a hinge 402. As the motor 502 moves the shaft 506, the movable barrier 202 can move from open to closed configuration.

FIG. 6A is an example diagram of an HVAC system 200 with a controller 602, according to some examples of the present disclosure. The systems and methods described herein provide an HVAC system 200 that can automatically increase the efficiency of the overall system (e.g., by increasing the efficiency of the blower 230) depending on the mode of the HVAC system, whether it be in heating mode or cooling mode. In other words, the movable barriers 202 do not require manual movement by a user. The controller 602 can be used with any of the systems described above to detect when the system is in the heating mode or the cooling mode and output a control signal with instructions to position the movable barriers 202 accordingly.

The controller 602 can be in electrical communication with a movement system 400 that can move the movable barriers 202 from a closed configuration to an open configuration. The example HVAC system 200 in FIG. 6A includes a motor 502, like the examples shown in FIGS. 5A-5C, which is in accordance with some examples. Alternately or in addition, the controller 602 can be in electrical communication with a solenoid 406, like in FIGS. 4A and 4B. The controller 602 can output a control signal to the motor 502, solenoid 406, and the like with instructions to move the movable barriers 202 from the closed configuration to the open configuration.

The controller 602 can include a series of switches and relays that perform the same or similar logic as described above. For example, the system can trigger a relay off on the gas valve control signal to close one or more of the movable barriers 202. In addition, the system can include a mechanical design that causes the movable barriers 202 to open and/or close. An example mechanical design includes a wax-plug style thermostat that acts as an actuator for the movable barriers 202. If the wax-plug style thermostat is positioned near a heat exchange 240, the heat from the heat exchanger 240 can cause the piston to extend and move the movable barriers 202 into a closed configuration. As the system cools, the baffles can open as the piston retracts. In this example, the wax-plug style thermostat can act both as a controller 602 and a motor 502, as described above.

The HVAC system 200 can also include a thermostat 604 or other user interface for controller temperature of the HVAC system 200 (e.g., a remote user interface such as via a computing device, mobile device, or other device). The thermostat 604 can communicate with the controller 602 via a wired or a wireless connection (e.g., a typical thermostat on the wall may use a wired or wireless connection, but a computing device may use a wireless connection). The thermostat 604 can set the system to the cooling mode or the heating mode. The controller 602 can receive a setting signal from the thermostat 604 indicating whether the HVAC system 200 should be set to the heating mode or the cooling mode. The output signal by the controller 602 can, therefore, be based at least in part on the setting signal from the thermostat 604. To illustrate using a common-use example, a thermostat 604 can be installed inside the home of a user. The user can switch the thermostat 604 to a cooling mode. The setting signal can be sent from the thermostat 604 to the controller 602. The controller 602 can then send a control signal to the one or more motors 502/solenoids 406 to open the movable barriers 202 to increase the air flow 35 through the cabinet 220.

The HVAC system 200 can also include redundancies to ensure the movable barriers 202 are in the correct location when in the heating and/or cooling mode. For example, if the movement system 400 that moves the movable barriers 202 malfunctions, systems can be employed to ensure the HVAC system 200 provides mitigating steps. This can be particularly important when the movable barriers 202 are placed near the heat exchanger 240. If the movable barriers 202 are supposed to be closed but a malfunction causes them to be open, the excess air flow 35 can cause the heat exchanger 240 to overheat.

One redundancy can include one or more sensors 606A, 606B. The sensor 606A, 606B can be positioned within the cabinet 220 such that the sensor 606A, 606B can detect whether a movable barrier 202 is in the open or closed configuration. The sensor 606A, 606B can include an optical sensor, a switch, a pressure sensor, and/or the like. Using the example HVAC system 200 shown in FIG. 6A as an example, sensor 606A can include an optical sensor or a contact sensor such as a switch, a pressure sensor, and/or the like that can sense whether the movable barrier 202 is in the open configuration (the movable barriers 202 in FIG. 6A are in a closed configuration). Sensor 606B in the example HVAC system 200 can be an optical sensor. If the sensor 606B does not detect a presence of the movable barrier 202, the sensor 606B may identify that the movable barrier 202 is in an open configuration. Alternatively, or in addition, the motor 502 can also include the sensors. For example, the motor 502 can include a switch or other mechanism to indicate whether the movable barrier 202 is in an open or closed configuration. The motor 502 can indicate a position of the movable barrier 202 by including sensors dedicated for detecting location, such as, for example, the feedback sensors found in a servo motor.

The sensors 606A, 606B can be in electrical communication with the controller 602 and can output a sensor signal to the controller 602. The sensor signal can include instructions about whether the movable barrier 202 is in the open or closed configuration. If the sensors 606A, 606B output a sensor signal indicating that the movable barrier 202 is in the open configuration when the HVAC system 200 is in a heating mode, the controller 602 can employ a mitigating action. The controller 602 can, for example, output a control signal to the blower 230 to deactivate the heating element 240, close a gas valve, or otherwise stop the heating function. The controller 602 can also or in addition output a control signal to transition the movable barrier 202 from the open configuration to the closed configuration. The opposite is true as well; if the sensors 606A, 606B output a sensor signal indicating that the movable barrier 202 is in the closed configuration when the HVAC system 200 is in a cooling mode, the controller 602 can employ a mitigating action to either stop or reduce the cooling function or move the movable barrier 202 from the closed configuration to the open configuration.

Another redundancy can include one or more temperature sensors 608. The temperature sensor 608 can include a thermometer, thermocouple, thermistor, and/or the like. The temperature sensor 608 can be positioned downstream from the heat exchanger 240 so that the temperature sensor 608 can sense if the HVAC system 200 is heating the air flow 35. The temperature sensor 608 can output a temperature signal to the controller 602. This temperature signal can be used by the controller 602 to determine if the HVAC system 200 is in a heating mode. To illustrate, the HVAC system 200 can be set to a cooling mode such that the movable barriers 202 are to be in an open configuration. The temperature sensor 608 can monitor the temperature of the air flow 35 in the cabinet 220. If the temperature of the air is above a first temperature (e.g., above 100° F.), this can indicate that the heat exchanger 240 is providing heat despite the system being in the cooling mode. The temperature sensor 608 can output a temperature signal to the controller 602 indicating that the air flow 35 is above the first temperature. The controller 602 can then mitigate by, for example, outputting a control signal to the blower 230 to deactivate the blower and/or outputting a control signal to transition the movable barrier 202 from the open configuration to the closed configuration, as described above for the sensor. The opposite is true as well; if the temperature is below a certain temperature when in a heating mode, the controller 602 may mitigate by deactivating the heat exchanger 240 (e.g., by deactivating a gas supply to the exchanger) and/or opening the movable barriers 202.

Yet another redundancy to determine if the movable barriers 202 are in the correct position with respect to heating or cooling mode can include providing pressure sensors that can measure the static pressure drop across the heat exchanger 240 to determine if the system is in a heating or cooling mode. The static pressure before and after the heat exchanger 240 could be measured, and a differential in pressure can indicate that the heat exchanger 240 is operating (or not operating). The location of the pressure sensors could be located, for example, where sensors 606A, 606B are located in FIG. 6A.

Yet another redundancy to determine if the movable barriers 202 are in the correct position with respect to heating or cooling mode can include flow sensors (e.g., air flow sensors) disposed within the cabinet 220 to determine if the rate of the air flow 35 at any given location within the cabinet. For example, the flow sensor can be positioned proximate the heat exchanger 240 (e.g., where the temperature sensor 608 is shown in FIG. 6A) and can sense if air is being redirected by the movable barriers 202.

Yet another redundancy to determine if the movable barriers 202 are in the correct position with respect to heating or cooling mode can include monitoring the power consumption of the blower 230 at any given time. For example, if the power consumption of the blower 230 is above a predetermined threshold, this can indicate that the movable barriers 202 are in a closed configuration, thereby directing the air flow 35 through the heat exchanger 240. It should be noted that any and all of the above redundancies can be used alone or in combination with any other redundancy.

FIG. 6B is a component diagram of an example controller 602, according to some examples of the present disclosure. The controller 602 can include a processor 610. The processor 610 can receive the signals (e.g., setting signals, sensor signals, and/or temperature signals) and determine whether the movable barrier 202 is in an open or closed configuration and/or should be moved to the other configuration. The processor 610 can include one or more of a microprocessor, microcontroller, digital signal processor, co-processor and/or the like or combinations thereof capable of executing stored instructions and operating upon data. The processor 610 can constitute a single core or multiple core processor that executes parallel processes simultaneously. For example, the processor 610 can be a single core processor that is configured with virtual processing technologies. The processor 610 can use logical processors to simultaneously execute and control multiple processes.

The controller 602 can include a memory 612. The memory 612 can be in communication with the one or more processors 610. The memory 612 can include instructions, for example a program 614 or other application, that causes the processor 610 and/or controller 602 to complete any of the processes described herein. For example, the memory 612 can include instructions that cause the controller 602 and/or processor 610 to receive signals (e.g., setting signals, sensor signals, and/or temperature signals) and determine whether the movable barrier 202 is in an open or closed configuration and/or whether the movable barrier 202 should be moved to the other configuration. The memory 612 can include, in some implementations, one or more suitable types of memory (e.g., volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs, executable instructions and data.

The controller 602 can be positioned proximate (e.g., attached to and/or within) the cabinet 220. Nothing requires the controller 602 to be positioned near the cabinet 220, however. That is, the controller 602 can be located remotely with respect to the cabinet 220. The controller 602 can, for example, be integrated into the thermostat 604 or another device (e.g., a computing device, a mobile device, etc.). The controller 602 can communicate with the various components of the HVAC system with one or more input/output (I/O) devices 616. The I/O device 616 can include one or more interfaces for receiving signals or input from devices and providing signals or output to one or more devices that allow data to be received and/or transmitted by the controller 602. The I/O device 616 can facilitate wired or wireless connections with any of the components described herein.

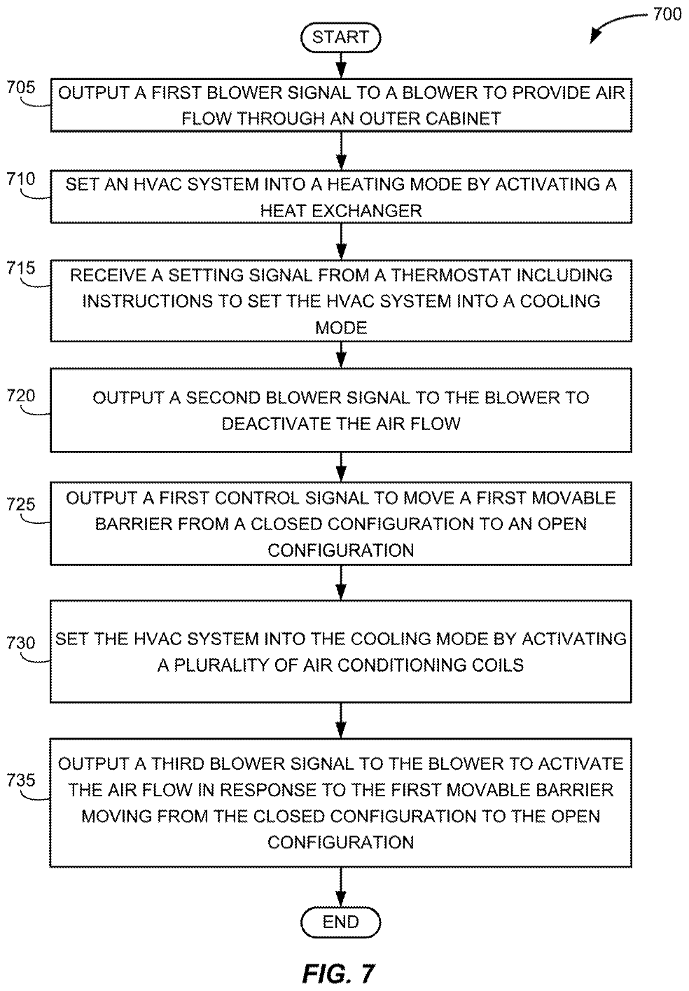

FIG. 7 is a flowchart showing an example process 700 for a controller, for example controller 602, according to some examples of the present disclosure. Process 700 can begin at step 705, where the controller can output a first blower signal to the blower (e.g., blower 230) to provide air flow through an outer cabinet. The blower signal can be similar to the control signals described herein for moving the movable barriers.

At step 710, process 700 can include setting an HVAC system (e.g., HVAC system 200) into a heating mode by activating a heat exchanger (e.g., heat exchanger 240). The instructions to initially set the system to the heating mode can be transmitted to the controller such as by a thermostat, for example.

At step 715, process 700 can include receiving a setting signal from the thermostat including instructions to set the HVAC system into a cooling mode. In response to the HVAC system being set into the cooling mode, at step 720, process 700 can include outputting a second blower signal to the blower to deactivate the air flow. By deactivating the air flow through the cabinet, movable barriers of the system can be moved without being subjected to additional air resistance. Alternatively, however, the movable barriers can be moved while the air is flowing through the cabinet.

At step 725, process 700 can include outputting a first control signal to move a first movable barrier from a closed configuration to an open configuration. At step 730, process 700 can include setting the HVAC system into the cooling mode by activating a plurality of air conditioning coils (e.g., AC coils 302). At step 735, process 700 can include outputting a third blower signal to the blower to activate the air flow in response to the first movable barrier moving from the closed configuration to the open configuration.

Process 700 can end after step 735. Alternatively, other processes can be completed according to the systems and methods described herein. For example, the controller can output instructions associated with the redundancies described herein to enable mitigating protocols. The controller can receive a temperature signal from a temperature sensor indicating that the air flow is above a first temperature when the HVAC system is in the cooling mode. In response, the controller can output a second control signal with instructions to either (1) deactivate the heat (e.g., turn off the gas or power to the heating element 240) or (2) move the first movable barrier from the open configuration to the closed configuration. The controller can receive, when the HVAC system is in the heating mode, a sensor signal from a sensor indicating the first movable barrier is in an open configuration. In response, the controller can output a second control signal with instructions to either (1) deactivate the heating function or (2) move the first movable barrier from the open configuration to the closed configuration.

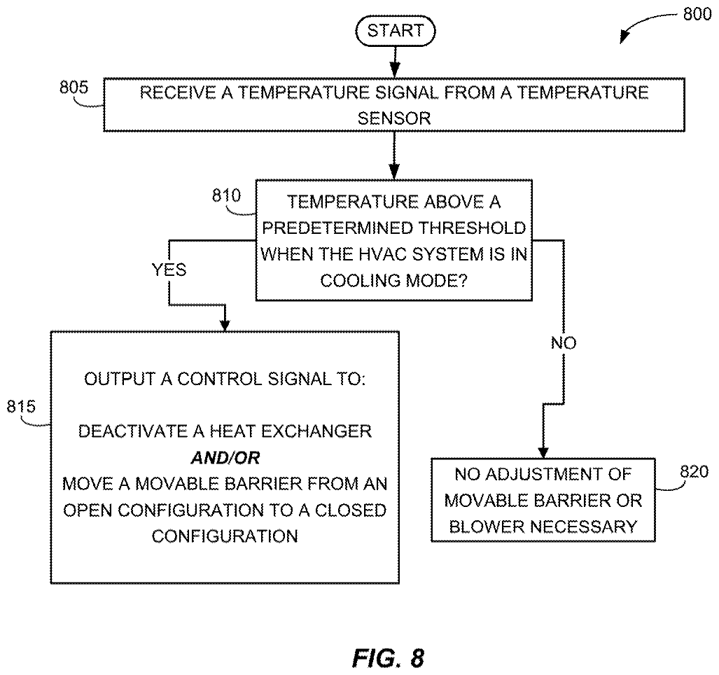

FIG. 8 is an example process 800 flow for using a temperature sensor, for example temperature sensor 608, as a redundancy to ensure the HVAC system is configured properly. Process 800 can begin at step 805, which can include receiving, at a controller (e.g., controller 602), a temperature signal from the temperature sensor. At step 810, process 800 can include determining whether the temperature of the air flow throw the air conduit (e.g., cabinet 220) is above a predetermined threshold when the HVAC system is in a cooling mode. As described above, the predetermined threshold can assist the controller in determining whether the system is blowing warm air when the system should be providing air conditioning. The threshold temperature could be, for example, 100° F. or any other temperature.

If the temperature of the air flow is above the predetermined temperature threshold, process 800 can proceed to step 815 which can include outputting, by the controller, an output signal to (1) deactivate a heating function (e.g., by deactivating the heating element) and/or (2) move a first movable barrier (or some or all moveable barriers) from the open configuration to the closed configuration.

If the air flow is not above the preterminal temperature threshold, process 800 can proceed to step 820 which includes maintaining the status quo as no adjustment is necessary to the blower or movable barrier.

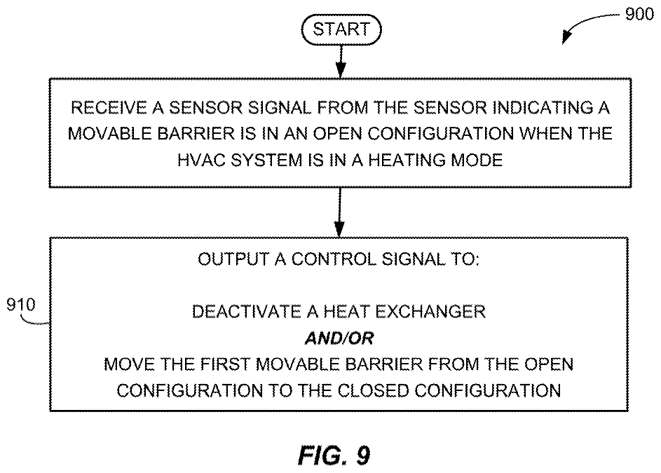

FIG. 9 is an example process 900 flow for using a sensor (e.g., sensor 606A, 606B) as a redundancy to ensure the HVAC system is configured properly, according to some examples of the present disclosure. Process 900 can begin at step 905, which can include receiving, at a controller (e.g., controller 602), a sensor signal from the sensor indicating a first movable barrier is in an open configuration when the HVAC system is in a heating mode. This can indicate that the first movable barrier is in the wrong configuration, as the system may require the movable barrier be closed when heating, as described above.

In response, at step 910 process 900 can include outputting, by the controller, an output signal to (1) deactivate a heating function and/or (2) move the first movable barrier from the open configuration to the closed configuration.

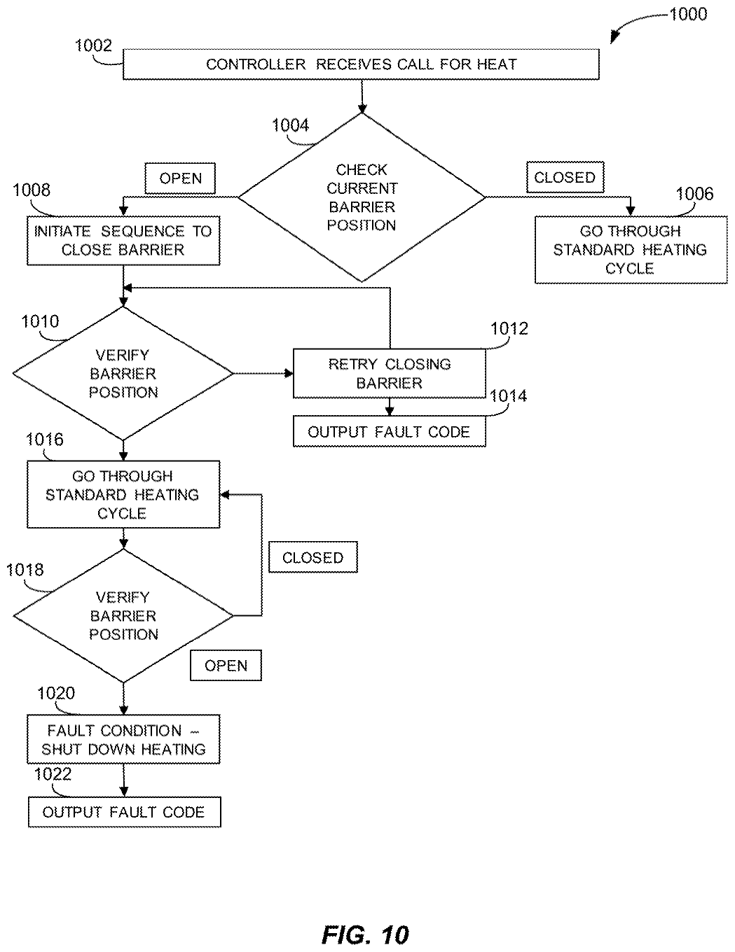

FIG. 10 is an example process 1000 flow for responding to a call for heat and providing heat through the system. The example process 1000 shown in FIG. 10 can be completed by any of the example systems described herein and can be used alone or in combination with any of the process flows described above. At step 1002, the controller (e.g., controller 602) can receive a call for heat. This call for heat, or setting to the heating mode, can be received from a thermostat (e.g., thermostat 604), an I/O device (e.g., I/O device 616), or another device (e.g., a computing device, a mobile device, etc.).

At step 1004, the position of the movable barriers can be checked for proper position. This can be completed by sensors in the cabinet (e.g., cabinet 220) of the system or by sensors within the movement mechanism that moves the movable barriers. If the movable barriers are closed, this is the proper position for heating, so the process 1000 can proceed to step 1006, where the system goes through a standard heating cycle.

If the movable barriers are open, at step 1008 the sequence to close the barriers can be initiated. For example, a control signal, as described above, can be sent to one or more movable barriers to transition them to a closed configuration. After the control signal is sent to the barriers, at step 1010 the position of the movable barriers can again be checked to ensure they are in the closed configuration, similar to step 1004 above. If the movable barriers remain open, at step 1012 the system can retry closing the barrier. At step 1014 a fault code can be output to the controller, the thermostat, the I/O device, or another device indicating that there was an error in transitioning the barriers into a closed configuration.

If the baffles remain closed in step 1010, the system can go through a standard heating cycle at step 1016. The system can continue to monitor the system to ensure the barriers are in the correct position, for example at step 1018. If the barriers at any time are deemed to be open, at step 1020 fault conditioning can be performed. This can include any of the mitigation protocols described above, for example deactivating a blower, deactivating a heat exchanger, deactivating gas or power to the heat exchanger, etc. In addition to the fault conditioning, process 1000 can include outputting a fault code at step 1022, similar to the fault code described in step 1014.

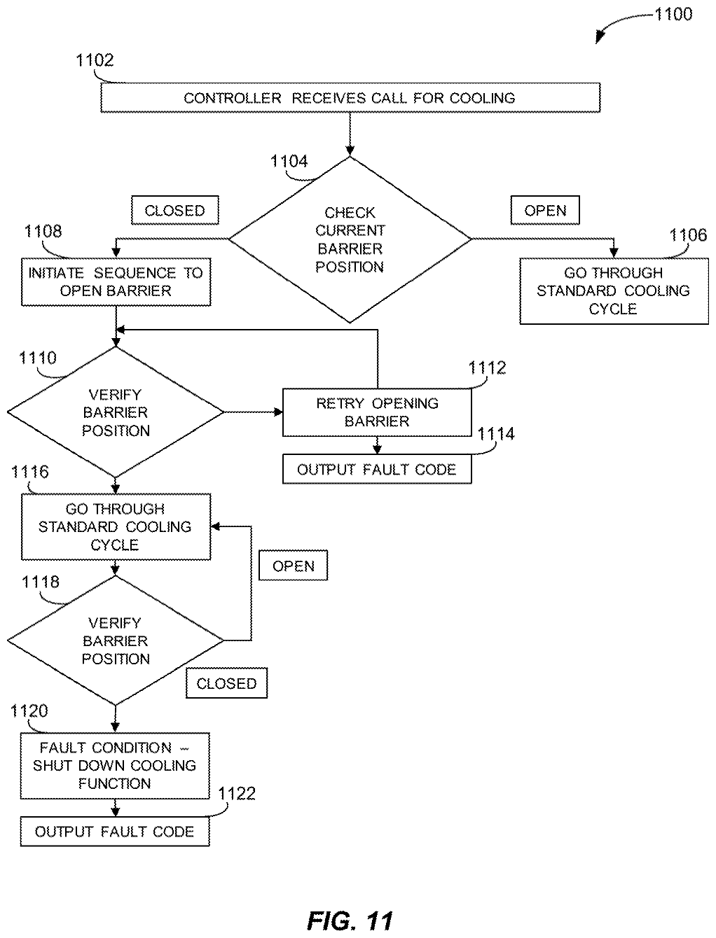

FIG. 11 is an example process 1100 flow for responding to a call for cooling and providing air conditioning through the system. The example process 1100 shown in FIG. 11 is substantially similar to the process 1000 described above in FIG. 10, but with respect to cooling instead of heating. The example process 1100 shown in FIG. 11 can be completed by any of the example systems described herein and can be used alone or in combination with any of the process flows described above. At step 1102, the controller (e.g., controller 602) can receive a call for cooling. This call for cooling (or air conditioning), or setting to the cooling mode, can be received from a thermostat (e.g., thermostat 604), an I/O device (e.g., I/O device 616), or another device (e.g., a computing device, a mobile device, etc.).

At step 1104, the position of the movable barriers can be checked for proper position. This can be completed by sensors in the cabinet (e.g., cabinet 220) of the system or by sensors within the movement mechanism that moves the movable barriers. If the movable barriers are open, this is the proper position for cooling, so the process 1100 can proceed to step 1106, where the system goes through a standard cooling cycle.

If the movable barriers are closed, at step 1108 the sequence to open the barriers can be initiated. For example, a control signal, as described above, can be sent to one or more movable barriers to transition them to an open configuration. After the control signal is sent to the barriers, at step 1110 the position of the movable barriers can again be checked to ensure they are in the open configuration, similar to step 1104 above. If the movable barriers remain closed, at step 1112 the system can retry opening the barrier. At step 1114 a fault code can be output to the controller, the thermostat, the I/O device, or another device indicating that there was an error in transitioning the barriers into an open configuration.

If the baffles remain open in step 1110, the system can go through a standard cooling cycle at step 1116. The system can continue to monitor the system to ensure the barriers are in the correct position, for example at step 1118. If the barriers at any time are deemed to be closed, at step 1120 fault conditioning can be performed. This can include any of the mitigation protocols described above, for example deactivating a blower and/or deactivating an air conditioning system (e.g., AC coils 302). In addition to the fault conditioning, process 1100 can include outputting a fault code at step 1122, similar to the fault code described in step 1114.

Certain examples and implementations of the disclosed technology are described above with reference to block and flow diagrams according to examples of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams do not necessarily need to be performed in the order presented, can be repeated, or do not necessarily need to be performed at all, according to some examples or implementations of the disclosed technology. It is also to be understood that the mention of one or more method steps does not preclude the presence of additional method steps or intervening method steps between those steps expressly identified. Additionally, method steps from one process flow diagram or block diagram can be combined with method steps from another process diagram or block diagram. These combinations and/or modifications are contemplated herein.

It should also be noted that, as used in the specification and the appended claims, the singular forms “a,” “an,” and “the” include plural references unless the context clearly dictates otherwise. References to a composition containing “a” constituent is intended to include other constituents in addition to the one named.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

While the present disclosure has been described in connection with a plurality of exemplary aspects, as illustrated in the various figures and discussed above, it is understood that other similar aspects can be used, or modifications and additions can be made, to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter. Additionally, the components described herein may apply to any other component within the disclosure. Merely discussing a feature or component in relation to one embodiment does not preclude the feature or component from being used or associated with another embodiment.

What is claimed is:

1. A system for heating and cooling comprising:
a controller configured to output a control signal based on whether the system is in a heating mode or a cooling mode; and
one or more movable barriers configured to transition between an open configuration and a closed configuration based on the control signal, wherein when at least one movable barrier of the one or more movable barriers is in the closed configuration, the at least one movable barrier blocks a portion of an air flow conduit such that an air flow flowing through the air flow conduit is redirected and constricted.

2. The system of claim 1, wherein the one or more movable barriers is positioned proximate a heat exchanger of the system such that, when the at least one moveable barrier is in the closed configuration, the at least one moveable barrier directs the air flow across the heat exchanger.

3. The system of claim 2, further comprising a plurality of air conditioning coils,
wherein the at least one movable barrier is configured to increase flow across the air conditioning coils when the at least one movable barrier is in the open configuration.

4. The system of claim 1, further comprising a thermostat configured to set the system to the cooling mode or the heating mode and output a setting signal to the controller,
wherein the controller is configured to generate the control signal based on the setting signal.

5. The system of claim 1, further comprising a temperature sensor configured to:
detect a temperature of the air flow; and
output a temperature signal to the controller indicating that the air flow is above a first temperature,
wherein, in response to the temperature signal, the control signal includes instructions to either:
shut down a heat exchanger; or
transition the at least one movable barrier from the open configuration to the closed configuration.

6. The system of claim 1, further comprising a sensor configured to:
detect whether the at least one movable barrier is in the open configuration or the closed configuration; and
output, when the system is in the heating mode, a sensor signal to the controller indicating that the at least one movable barrier is in the open configuration,
wherein, in response to the sensor signal, the control signal includes instructions to either:
shut down a heat exchanger; or
transition the at least one movable barrier from the open configuration to the closed configuration.

7. The system of claim 6, wherein the sensor is an optical sensor or a switch.

8. The system of claim 1, further comprising a motor in electrical communication with the controller and configured to change the at least one movable barrier from the closed configuration to the open configuration.

9. The system of claim 1, further comprising:
a spring configured to open the at least one movable barrier from the closed configuration to the open configuration; and
a solenoid configured to secure the at least one movable barrier in the closed configuration and the open configuration,
wherein the at least one movable barrier is configured to closed from the open configuration to the closed configuration in response to the air flow.

10. A heating, ventilation, and air conditioning (HVAC) system comprising:
an outer cabinet;
a blower configured to provide an air flow through the outer cabinet;
a movable barrier having an open configuration and a closed configuration, the movable barrier configured to constrict air flow through the outer cabinet when in the closed configuration; and
a controller configured to output a control signal with instructions to move the movable barrier from the open configuration when the HVAC system is in a cooling mode to the closed configuration when the HVAC system is in a heating mode.

11. The HVAC system of claim 10, further comprising a heat exchanger, wherein the movable barrier is positioned proximate the heat exchanger.

12. The HVAC system of claim 10, further comprising a thermostat configured to output a setting signal to the controller indicating whether the HVAC system is set to the cooling mode or the heating mode,
wherein the control signal is based at least in part on the setting signal.

13. The HVAC system of claim 10, further comprising a temperature sensor configured to:
detect a temperature of the air flow; and
output a temperature signal to the controller indicating that the air flow is above a first temperature,
wherein, in response to the temperature signal, the control signal includes instructions to either:
shut down a heat exchanger; or
transition the movable barrier from the open configuration to the closed configuration.

14. The HVAC system of claim 10, further comprising a sensor configured to:
detect whether the movable barrier is in the open configuration or the closed configuration; and
output, when the HVAC systems is in the heating mode, a sensor signal to the controller indicating that the movable barrier is in the open configuration,
wherein, in response to the sensor signal, the control signal includes instructions to either:
deactivate the blower; or
transition the movable barrier from the open configuration to the closed configuration.

15. The HVAC system of claim 14, wherein the sensor is an optical sensor or a switch.

16. The HVAC system of claim 10, further comprising a motor in electrical communication with the controller and configured to move the movable barrier from the closed configuration to the open configuration.

17. A controller for a heating, ventilation, and air conditioning (HVAC) system, the controller having a processor and memory storing instructions that, when executed by the processor, cause the controller to:
determine whether the HVAC system is in a heating mode or a cooling mode;
in response to determining that the system is in the heating more, output a first control signal to move a movable barrier to a closed configuration; and
in response to determining that the system is in the cooling mode, output a second control signal to move the movable barrier to an open configuration.

18. The controller for the HVAC system of claim 17, wherein the instructions, when executed by the processor, further cause the controller to:
in response to determining that the system is in the cooling mode, receive a temperature signal from a temperature sensor indicating that an air flow through an air conduit is above a predetermined temperature; and
output a third control signal to either:
deactivate a heat exchanger; or
move the movable barrier from the open configuration to the closed configuration.

19. The controller for the HVAC system of claim 17, wherein the instructions, when executed by the processor, further cause the controller to:
in response to determining that the system is in the heating mode, receive a sensor signal from a sensor indicating the movable barrier is in the open configuration; and
output a third control signal to either:
deactivate a heat exchanger; or
move the movable barrier from the open configuration to the closed configuration.

20. The controller for the HVAC system of claim 17, wherein:
outputting the first control signal includes transmitting the first control signal to a motor to move first movable barrier to the closed configuration; and
outputting the second control signal includes transmitting the second control signal to the motor to move the movable barrier to the open configuration.
